(19) United States
(12) Patent Application Publication
(10) Pub. No.: US 2016/0227470 A1
(43) Pub. Date: Aug. 4, 2016

(54) BLUETOOTH LOW ENERGY PACKETS

(71) Applicant: NOKIA TECHNOLOGIES OY, Espoo (FI)

(72) Inventor: Jia LIU, Beijing (CN)

(21) Appl. No.: 15/021,423

(22) PCT Filed: Sep. 18, 2013
(86) PCT No.: PCT/CN2013/083761

§ 371 Date: Mar. 11, 2016

(51) Int. Cl. H04W 48/10; H04W 4/00

(52) U.S. Cl. CPC H04W 48/10; H04W 4/008

(57) ABSTRACT

A method comprises causing formation and transmission from a first terminal of a Bluetooth low energy (BLE) advertising packet, the BLE advertising packet comprising an indication that content is available for transmission, and responding to receipt from a second terminal, which received the BLE advertising packet, of an indication that the content is required to be transmitted to the second terminal by causing transmission of the content from the first terminal to the second terminal.

### FIELD

This specification relates to Bluetooth Low Energy packets.

### BACKGROUND

Bluetooth Low Energy (BLE) is a new wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of classical Bluetooth, BLE redefines the physical layer specification, and involves many new features such as a very-low power idle mode, a simple device discovery, and short data packets.

BLE technology is well-suited for devices requiring low power consumption, for example devices that may operate with one or more button cell batteries such as sensors, key fobs, and/or the like. BLE can also be incorporated into devices such as mobile phones, smart phones, tablet computers, laptop computers and desktop computers.

### SUMMARY

In a first aspect, this specification describes a method comprising: causing formation and transmission from a first terminal of a Bluetooth low energy (BLE) advertising packet, the BLE advertising packet comprising an indication that content is available for transmission; and responding to receipt from a second terminal, which received the BLE advertising packet, of an indication that the content is required to be transmitted to the second terminal by causing transmission of the content from the first terminal to the second terminal.

The indication that the content is required to be transmitted to the second terminal may be, or may be included in, another BLE packet.

The formation and transmission of the BLE advertising packet may be caused in response to a determination that the content is present in a virtual clipboard. Determining that the content is present in the virtual clipboard may comprise detecting performance of a copy operation in which the content is copied to the virtual clipboard.

The BLE advertising packet may comprise at least part of the content for enabling the second terminal to provide a preview of the content to a user. The BLE advertising packet may comprise an indication of a type of the content available for transmission. The BLE advertising packet may comprise an indication of a size of the content available for transmission.

The method may comprise determining, based on at least a property associated with the content, a transmission protocol by which to transmit the content from the first terminal to the second terminal.

The transmission of the content from the first terminal to the second terminal may be via a communications protocol other than BLE. Alternatively, the transmission of the content from the first terminal to the second terminal may be via a BLE connection.

The method may comprise responding to receipt of the indication that the content is required to be transmitted or to the transmission of the content by preventing further transmissions of the BLE advertising packet.

In a second aspect, this specification describes a method comprising: receiving from a first terminal at a second terminal a Bluetooth low energy (BLE) advertising packet, the BLE advertising packet comprising an indication that content is available for transmission from the first terminal; causing transmission to the first terminal of an indication that the content is required to be transmitted to the second terminal; and receiving the content from the first terminal at the second terminal.

The BLE advertising packet may include at least part of the content that is available for transmission from the first terminal. The method may comprise causing provision to the user of the second terminal, based on the at least part of the content included in the advertising packet, a preview of the content that is available for transmission.

The BLE advertising packet may include an indication of a type of the content available for transmission. The BLE advertising packet may include an indication of a size of the content available for transmission.

The method may comprise causing the transmission of the indication that the content is required to be transmitted to the second terminal in response to receipt of a user input indicating that the content is required to be transmitted.

The method may comprise responding to receipt of the BLE advertising packet by enabling a user selectable option for allowing the user of the second terminal to indicate that the content is required to be transmitted to the second terminal, wherein the user input comprises selection by the user of the selectable option.

The content may be received from the first terminal at the second terminal via a communications protocol other than BLE. Alternatively, the content may be received from the first terminal at the second terminal via a BLE connection.

In a third aspect, this specification describes a method comprising causing formation and transmission from a first terminal of a Bluetooth low energy (BLE) advertising packet, the BLE advertising packet comprising: an indication that content is available for transmission; and at least one of: at least part of the content for enabling a second terminal, which receives the BLE advertising packet, to provide a preview of the content to a user; an indication of a type of the content available for transmission; and an indication of a size of the content available for transmission.

In a fourth aspect, this specification describes an apparatus configured: to cause formation and transmission from a first terminal of a Bluetooth low energy (BLE) advertising packet, the BLE advertising packet comprising an indication that content is available for transmission; and to respond to receipt from a second terminal, which received the BLE advertising packet, of an indication that the content is required to be transmitted to the second terminal by causing transmission of the content from the first terminal to the second terminal.

The indication that the content is required to be transmitted to the second terminal may be, or may be included in, another BLE packet.

The apparatus may be configured to cause the formation and transmission of the BLE advertising packet in response to a determination that the content is present in a virtual clipboard.

The determination that the content is present in the virtual clipboard may comprise detection of performance of a copy operation in which the content is copied to the virtual clipboard.

The BLE advertising packet may comprise at least part of the content for enabling the second terminal to provide a preview of the content to a user. The BLE advertising packet may comprise an indication of a type of the content available for transmission. The BLE advertising packet may comprise an indication of a size of the content available for transmission.

The apparatus may be configured to determine, based on at least a property associated with the content, a transmission protocol by which to transmit the content from the first terminal to the second terminal.

The transmission of the content from the first terminal to the second terminal may be via a communications protocol other than BLE. Alternatively, the transmission of the content from the first terminal to the second terminal may be via a BLE connection.

The apparatus may be configured to respond to receipt of the indication that the content is required to be transmitted or to the transmission of the content by preventing further transmissions of the BLE advertising packet.

The apparatus may be the first terminal. The first terminal may be a portable electronic device, such as a smart phone or a tablet computer.

In a fifth aspect, this specification describes apparatus configured: to enable receipt from a first terminal at a second terminal a Bluetooth low energy (BLE) advertising packet, the BLE advertising packet comprising an indication that content is available for transmission from the first terminal; to cause transmission to the first terminal of an indication that the content is required to be transmitted to the second terminal; and to enable receipt of the content from the first terminal at the second terminal.

The BLE advertising packet may include at least part of the content that is available for transmission from the first terminal. The apparatus may be configured to cause provision to the user of the second terminal, based on the at least part of the content included in the advertising packet, a preview of the content that is available for transmission.

The BLE advertising packet may include an indication of a type of the content available for transmission. The BLE advertising packet may include an indication of a size of the content available for transmission.

The apparatus may be configured to cause the transmission of the indication that the content is required to be transmitted to the second terminal in response to receipt of a user input indicating that the content is required to be transmitted. The apparatus may be configured: to respond to receipt of the BLE advertising packet by enabling a user selectable option for allowing the user of the second terminal to indicate that the content is required to be transmitted to the second terminal, wherein the user input comprises selection by the user of the selectable option.

The content may be received from the first terminal at the second terminal via a communications protocol other than BLE. The content may be received from the first terminal at the second terminal via a BLE connection.

The apparatus may be the second terminal. The second terminal may be a portable electronic device, such as a smart phone or a tablet computer.

In a sixth aspect, this specification describes apparatus configured to cause formation and transmission from a first terminal of a Bluetooth low energy (BLE) advertising packet, the BLE advertising packet comprising: an indication that content is available for transmission; and at least one of: at least part of the content for enabling a second terminal, which receives the BLE advertising packet, to provide a preview of the content to a user; an indication of a type of the content available for transmission; and an indication of a size of the content available for transmission.

The apparatus may be the first terminal. The first terminal may be a portable electronic device, such as a smart phone or a tablet computer.

In a seventh aspect, this specification describes computer-readable code which, when executed by computing apparatus, causes the computing apparatus to perform a method according to any one of the first to third aspects.

In an eighth aspect, this specification describes apparatus comprising: at least one processor; and at least one memory including computer program code, the at least one memory and the computer program code configured to, with the at least one processor, cause the apparatus at least: to cause formation and transmission from a first terminal of a Bluetooth low energy (BLE) advertising packet, the BLE advertising packet comprising an indication that content is available for transmission; and to respond to receipt from a second terminal, which received the BLE advertising packet, of an indication that the content is required to be transmitted to the second terminal by causing transmission of the content from the first terminal to the second terminal.

The indication that the content is required to be transmitted to the second terminal may be, or may be included in, another BLE packet.

The at least one memory and the computer program code may be configured to, with the at least one processor, cause the apparatus to cause the formation and transmission of the BLE advertising packet in response to a determination that the content is present in a virtual clipboard. The determination that the content is present in the virtual clipboard may comprise detection of performance of a copy operation in which the content is copied to the virtual clipboard.

The BLE advertising packet may comprise at least part of the content for enabling the second terminal to provide a preview of the content to a user. The BLE advertising packet may comprise an indication of a type of the content available for transmission. The BLE advertising packet may comprise an indication of a size of the content available for transmission.

The at least one memory and the computer program code may be configured to, with the at least one processor, cause the apparatus to determine, based on at least a property associated with the content, a transmission protocol by which to transmit the content from the first terminal to the second terminal.

The transmission of the content from the first terminal to the second terminal may be via a communications protocol other than BLE. Alternatively, the transmission of the content from the first terminal to the second terminal may be via a BLE connection.

The at least one memory and the computer program code may be configured to, with the at least one processor, cause the apparatus to respond to receipt of the indication that the content is required to be transmitted or to the transmission of the content by preventing further transmissions of the BLE advertising packet.

The apparatus may be the first terminal. The first terminal may be a portable electronic device, such as a smart phone or a tablet computer.

In a ninth aspect, this specification describes apparatus comprising: at least one processor; and at least one memory including computer program code, the at least one memory and the computer program code configured to, with the at least one processor, cause the apparatus at least: to enable receipt from a first terminal at a second terminal a Bluetooth low energy (BLE) advertising packet, the BLE advertising packet comprising an indication that content is available for transmission from the first terminal; to cause transmission to the first terminal of an indication that the content is required to be transmitted to the second terminal; and to enable receipt of the content from the first terminal at the second terminal.

The BLE advertising packet may include at least part of the content that is available for transmission from the first terminal. The at least one memory and the computer program code may be configured to, with the at least one processor, cause the apparatus to cause provision to the user of the second terminal, based on the at least part of the content included in the advertising packet, a preview of the content that is available for transmission.

The BLE advertising packet may include an indication of a type of the content available for transmission. The BLE advertising packet may include an indication of a size of the content available for transmission.

The at least one memory and the computer program code may be configured to, with the at least one processor, cause the apparatus to cause the transmission of the indication that the content is required to be transmitted to the second terminal in response to receipt of a user input indicating that the content is required to be transmitted.

The at least one memory and the computer program code may be configured to, with the at least one processor, cause the apparatus to respond to receipt of the BLE advertising packet by enabling a user selectable option for allowing the user of the second terminal to indicate that the content is required to be transmitted to the second terminal, wherein the user input comprises selection by the user of the selectable option.

The content may be received from the first terminal at the second terminal via a communications protocol other than BLE. Alternatively, the content may be received from the first terminal at the second terminal via a BLE connection.

The apparatus may be the second terminal. The second terminal may be a portable electronic device, such as a smart phone or a tablet computer.

In a tenth aspect, this specification describes apparatus comprising: at least one processor; and at least one memory including computer program code, the at least one memory and the computer program code configured to, with the at least one processor, cause the apparatus at least: to cause formation and transmission from a first terminal of a Bluetooth low energy (BLE) advertising packet, the BLE advertising packet comprising: an indication that content is available for transmission; and at least one of: at least part of the content for enabling a second terminal, which receives the BLE advertising packet, to provide a preview of the content to a user; an indication of a type of the content available for transmission; and an indication of a size of the content available for transmission.

The apparatus may be the first terminal. The first terminal may be a portable electronic device, such as a smart phone or a tablet computer.

In an eleventh aspect, this specification describes a non-transitory computer-readable storage medium having stored thereon computer-readable code, which, when executed by computing apparatus, causes the computing apparatus to perform a method comprising: causing formation and transmission from a first terminal of a Bluetooth low energy (BLE) advertising packet, the BLE advertising packet comprising an indication that content is available for transmission; and responding to receipt from a second terminal, which received the BLE advertising packet, of an indication that the content is required to be transmitted to the second terminal by causing transmission of the content from the first terminal to the second terminal.

In a twelfth aspect, this specification describes a non-transitory computer-readable storage medium having stored thereon computer-readable code, which, when executed by computing apparatus, causes the computing apparatus to perform a method comprising: receiving from a first terminal at a second terminal a Bluetooth low energy (BLE) advertising packet, the BLE advertising packet comprising an indication that content is available for transmission from the first terminal; causing transmission to the first terminal of an indication that the content is required to be transmitted to the second terminal; and receiving the content from the first terminal at the second terminal.

In a thirteenth aspect, this specification describes non-transitory computer-readable storage medium having stored thereon computer-readable code, which, when executed by computing apparatus, causes the computing apparatus to perform a method comprising: causing formation and transmission from a first terminal of a Bluetooth low energy (BLE) advertising packet, the BLE advertising packet comprising: an indication that content is available for transmission; and at least one of: at least part of the content for enabling a second terminal, which receives the BLE advertising packet, to provide a preview of the content to a user; an indication of a type of the content available for transmission; and an indication of a size of the content available for transmission.

In a fourteenth aspect, this specification describes apparatus comprising: means for causing formation and transmission from a first terminal of a Bluetooth low energy (BLE) advertising packet, the BLE advertising packet comprising an indication that content is available for transmission; and means for responding to receipt from a second terminal, which received the BLE advertising packet, of an indication that the content is required to be transmitted to the second terminal by causing transmission of the content from the first terminal to the second terminal. The apparatus may further comprise means for performing any of the other operations described above with reference to the first aspect.

In a fifteenth aspect, this specification describes apparatus comprising: means for receiving from a first terminal at a second terminal a Bluetooth low energy (BLE) advertising packet, the BLE advertising packet comprising an indication that content is available for transmission from the first terminal; means for causing transmission to the first terminal of an indication that the content is required to be transmitted to the second terminal; and means for receiving the content from the first terminal at the second terminal. The apparatus may further comprise means for performing any of the other operations described above with reference to the second aspect.

In a sixteenth aspect, this specification describes apparatus comprising means for causing formation and transmission from a first terminal of a Bluetooth low energy (BLE) advertising packet, the BLE advertising packet comprising: an indication that content is available for transmission; and at least one of: at least part of the content for enabling a second terminal, which receives the BLE advertising packet, to provide a preview of the content to a user; an indication of a type of the content available for transmission; and an indication of a size of the content available for transmission.

In a seventeenth aspect, this specification describes a method comprising: causing formation and transmission from a first terminal of a Bluetooth low energy (BLE) advertising packet, the BLE advertising packet comprising an indication that content is available for transmission; receiving from the first terminal at a second terminal the BLE advertising packet; causing transmission from the second terminal to the first terminal of an indication that the content is required to be transmitted to the second terminal; responding to receipt at the first terminal of the indication that the content is required to be transmitted to the second terminal by causing transmission of the content from the first terminal to the second terminal; and receiving the content at the second terminal.

In an eighteenth aspect, this specification describes a system comprising a first terminal and a second terminal, the first terminal being configured: to cause formation and transmission from the first terminal of a Bluetooth low energy (BLE) advertising packet, the BLE advertising packet comprising an indication that content is available for transmission; and to respond to receipt at the first terminal of an indication that the content is required to be transmitted to the second terminal by causing transmission of the content from the first terminal to the second terminal, the second terminal being configured: to receive from the first terminal at the second terminal the Bluetooth low energy (BLE) advertising packet; to cause transmission to the first terminal of the indication that the content is required to be transmitted to the second terminal; and to receive the content from the first terminal at the second terminal.

In a nineteenth aspect, this specification describes a user terminal comprising the apparatus of any of the fourth, sixth, eighth and tenth aspects. The user terminal may be a portable electronic device such as, but not limited to, a smart phone and a tablet computer.

In a twentieth aspect, this specification describes a user terminal comprising the apparatus of either of the fifth and ninth aspects. The user terminal may be a portable electronic device such as, but not limited to, a smart phone and a tablet computer.

### BRIEF DESCRIPTION OF THE DRAWINGS

For a more complete understanding of examples of embodiments of the present invention, reference is now made to the following descriptions taken in connection with the accompanying drawings in which:

FIG. 1 is a simplified schematic illustrating a system according to examples of embodiments of the invention;

FIG. 2 illustrates a format of a BLE advertising message according to examples of embodiments of the invention;

FIG. 3 is a flow chart showing examples of operations which may be performed by the source apparatus of FIG. 1

FIG. 4 is a flowchart showing examples of operations which may be performed by the recipient apparatus of FIG. 2; and

FIGS. 5A and B is depict of example of non-transitory computer readable memory media on which may be stored computer-readable instructions configured to perform operations according to examples of embodiments of the invention.

### DETAILED DESCRIPTION

In the description and drawings, like reference numerals may refer to like elements throughout.

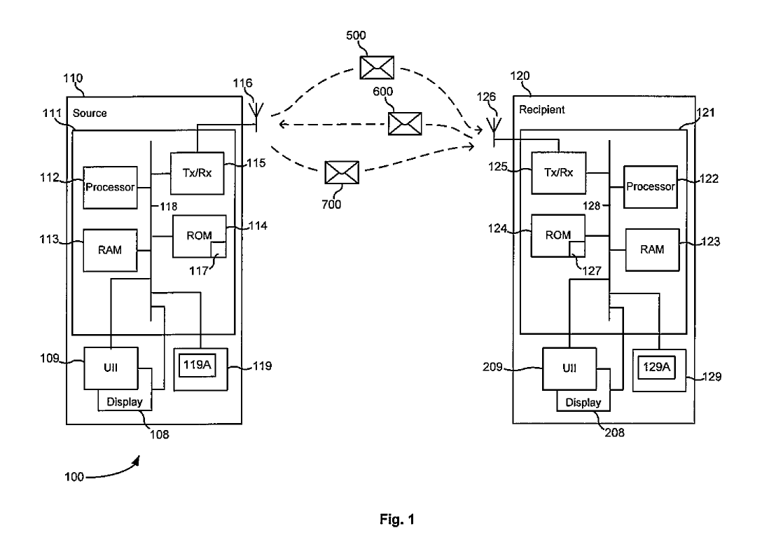

FIG. 1 shows a system including communication apparatuses according to examples of embodiments of the invention. The system 100 includes a first terminal 110 and a second terminal 120. The first and second terminals 110, 120 may be referred to as a source terminal and a recipient terminal respectively. As will be understood from the following description, in some examples the system 100 may comprise multiple recipient terminals 120. Similarly, in some examples, the system 100 may additionally or alternatively comprise more than one source terminal 110. Packets (which also may be referred to as messages), or sequences thereof, 500, 600, 700 which are passed between the first and second terminals 110, 120 are also depicted in FIG. 1.

Each of the terminals 110, 120 is a Bluetooth Low Energy-capable terminal. That is to say, each of the terminals 110, 120 is able to operate in accordance with the Bluetooth Low Energy (BLE) standard, currently at version 4.0.

The source terminal 110 includes BLE-capable apparatus 111. The BLE-capable apparatus 111 operates according to the BLE standard, currently at version 4.0. The recipient terminal 120 includes BLE-capable apparatus 121, which also operates according to the BLE standard. The BLE-capable apparatuses 111, 121 of each of the terminals 110, 120 may be referred to as BLE modules.

The BLE-capable apparatus 121 of the recipient terminal 120 includes processing circuitry 122. The processing circuitry 122 is connected to volatile memory such as RAM 123 by a bus 128. The bus 128 also connects the processing circuitry 122 and the RAM 123 to non-volatile memory, such as ROM 124. A transceiver 125 is coupled to the bus 128, and thus also to the processing circuitry 122 and the memories 123, 124. An antenna 126 is coupled to the transceiver 125. Within the ROM 124 is stored a computer program 127. This may be in the form of firmware. Alternatively, it may be in the form of an operating system and one or more applications, for instance.

In the BLE-capable apparatus 111 of the source terminal 110, processing circuitry 112, RAM 113, ROM 114, a transceiver 115, an antenna 116, software 117 and a bus 118 may be constituted and connected in the same way as in the corresponding components of the BLE-capable apparatus 121 of the recipient terminal 120.

Each of the BLE-capable apparatuses 111, 121 may take any suitable form. Generally speaking, the BLE-capable apparatuses 111, 121 may comprise processing circuitry 112, 122, including one or more processors, and a storage device 114, 113, 124, 123, comprising a single memory unit or a plurality of memory units. The storage device 114, 113,124, 123 may store computer program instructions 117, 127 that, when loaded into the processing circuitry 122, 112, control the operation of the BLE-capable apparatus 111, 121.

In addition to their respective BLE-capable apparatus 111, 121, the source and recipient terminals 110, 120 may comprise a number of other components. Such components may include a display 108, 208 configured, under the control of the processing circuitry 112, 122 and the computer-readable code 117, 127, to display information to the user of the terminal and a user input interface 109, 209 configured to receive user inputs and to output to the processing circuitry 112, 122 signals indicative of the received user inputs. The user input interface 109, 209 may be, for example, a touch-sensitive panel, which may or may not be combined with the display 108, 208 to form a touchscreen. The user input interface 109, 209 may comprise, in addition or alternatively to a touch-sensitive panel, one or more different type of user-input interface including but not limited to one or more mechanical keys/buttons, an optical sensor and a voice recognition system. The terminals 110, 120 may also include additional components 119, 129 which may be dependent on the nature of the terminal. Examples of these components include but are not limited to loudspeakers, microphones, cameras and one or more additional communication interface 119A, 129A for communicating via protocols other than BLE.

The additional communication interfaces 119A, 129A may be configured to allow two-way communication with external devices and/or networks. The communication interfaces may be configured to communicate wirelessly via one or more of several protocols such as Global System for Mobile Communications (GSM), Code Division Multiple Access (CDMA), Universal Mobile Telecommunications System (UMTS) and IEEE 802.11 (Wi-Fi). Alternatively or additionally, the communication interfaces 119A, 129A may be configured for wired communication with a device or network.

The terminals 110, 120 may be of any suitable type of portable or non-portable terminal such as, but not limited to, a mobile phone, a smart phone, a tablet computer, a laptop computer, a smart watch and a personal computer. One or more of the terminals 110, 120 may be based around an operating system, for instance the Symbian operating system or Microsoft Windows operating system, although any other operating system may instead be used.

Generally speaking, embodiments of the invention facilitate the communication of content between terminals. Put in other terms, embodiments of the invention facilitate the “copying-and-pasting” of content between terminals. In particular, embodiments of the present invention allow content to be copied-and-pasted between terminals without a connection between the terminals having been previously established.

Nowadays, a single user may make use of many different types of terminal, each of which may be more or less suited to a particular task. As such, the user might interchange between their different terminals in order to perform different tasks in relation to the same project. For example, a user may receive an SMS alert via their smart phone regarding a news item of interest. In order to discover more about the news item, the user might switch to using their tablet (which may be better suited to internet browsing). While using their tablet, the user might see an image which is suitable for use in a presentation they are preparing. As such, the user may switch to their laptop to access the image and to include it in their presentation. Each time the user makes a switch to a different terminal (or device), they may have to go through a number of operations in order to access the content they were previously viewing on the previous type of terminal. Embodiments of the invention, provide a convenient, flexible and energy efficient way to share content between different terminals.

Briefly, the BLE-capable apparatus 111 of the source terminal 110 of FIG. 1 is configured to prepare and transmit a new type of BLE message, which may be a BLE advertising message or, more specifically, a BLE advertising channel packet.

More specifically, the BLE-capable apparatus 111 is configured to cause formation and transmission of a Bluetooth low energy (BLE) advertising packet 500 which comprises an indication that content is available for transmission from the terminal 110 in which the BLE-capable apparatus 111 is provided to another BLE-capable terminal (e.g. the recipient terminal 120 ). The BLE advertising packet may further comprise at least part of the content which may be suitable for use by the other BLE-capable terminal to provide a preview of the content to a user. The BLE advertising packet 500 may include an indication of a type of the content (such as but not limited to text, image, video, audio or a specific file type) that is available for transmission. The BLE advertising packet 500 may also or alternatively include an indication of a size of the content available for transmission.

The BLE-capable apparatus 111 of the source terminal 110 may be configured to respond, subsequently, to receipt from the recipient terminal 120 of an indication that the content is required to be transmitted to the recipient terminal 120 by transmitting the whole of the content 700 to the recipient terminal 120. The content may be transmitted to the recipient terminal via a BLE connection or via a communications protocol other than BLE such as Wi-Fi. The source terminal 110 may be configured to determine by which protocol to transmit the content based on a property of the content, for instance its size and or its content type. Other considerations, such as properties associated with the terminals may also or alternatively be taken into account. For example, the communication capabilities of one or both of the terminals may be considered.

The indication that the content is required to be transmitted to the recipient terminal 120 may be, or may be included in, a BLE message 600. For instance, the receipt of the BLE message 600 from the recipient terminal 120 may be sufficient indication that the content is required to be transmitted. Alternatively, the BLE message 600 may include a field indicating that the content is required to be transmitted. In some examples, a field in the message 600 may indicate that the content is not required, in which case the BLE-capable apparatus of the source terminal 110 does not transmit the content 700.

The BLE-capable apparatus 111 of the source terminal 110 may, if no indication that content is required to be transmitted is detected, transmit further instances of the BLE advertising packet 500. Transmissions of such further instances may be discontinued or prevented in response to detection of the indication that the content is required to be transmitted and/or the transmission of the whole of the content to the recipient terminal 120.

The formation and transmission of the BLE advertising packet 500 may be caused in response to a determination that the content is present in a virtual clipboard. A virtual clipboard may comprise, for example, an anonymous, temporary data buffer, which may be accessible via defined programming interfaces from most or all programs which are executable on the source terminal. The determination that the content is present in the virtual clipboard may comprise a detection of a copy operation in which the content is copied to the virtual clipboard. Alternatively, periodic determinations as to the occupancy of the virtual clipboard may be made. The temporary data buffer may be provided in a memory medium of the terminal 110, for example RAM 113.

The source terminal 110 may be settable, for example by a user providing a user input, into a particular mode and may be operable to perform the above operations, including formation and transmission of the BLE advertising packet 500 only if the terminal is in that mode. This mode may be referred to as the “Remote Clipboard” (RC) mode.

The BLE-capable apparatus 121 of the recipient terminal 120 may be configured to receive the BLE advertising packet 500 from the source terminal 120. Receipt of this packet 500 may trigger the BLE-capable apparatus 121 to cause provision, for example via the display 128, of a preview of the content to a user based on the at least part of the content received in the BLE advertising packet 500. Information regarding the size and/or the type of the content for transmission may be provided to the user simultaneously with or separately from the preview of the content. This may enable the user to make a more informed decision as to whether the content is required to be transmitted. As mentioned above, an indication as to the size and/or type of the content may be received in the BLE advertising packet 500.

The BLE-capable apparatus 121 may also be configured to transmit to the source terminal the indication, in the form of a BLE message 600, that the content is required to be transmitted to the recipient terminal 500. Subsequent to this, the recipient terminal 120 may receive, via BLE or another protocol, the whole of the content from the source terminal 110. The indication that the content is required to be transmitted to the recipient terminal 120 may be performed in response to an indication from the user via the user input interface 129 that the content is required to be transmitted. The BLE-capable apparatus may be configured to respond to receipt of the BLE advertising packet 500 by enabling a selectable option via which a user can indicate that the content is required to be transmitted.

Similarly as described with reference to the source terminal 110, the recipient terminal 120 may be settable into the RC mode and may be configured to respond to the receipt of the BLE advertising packet 500 as described above only if the terminal is in the RC mode.

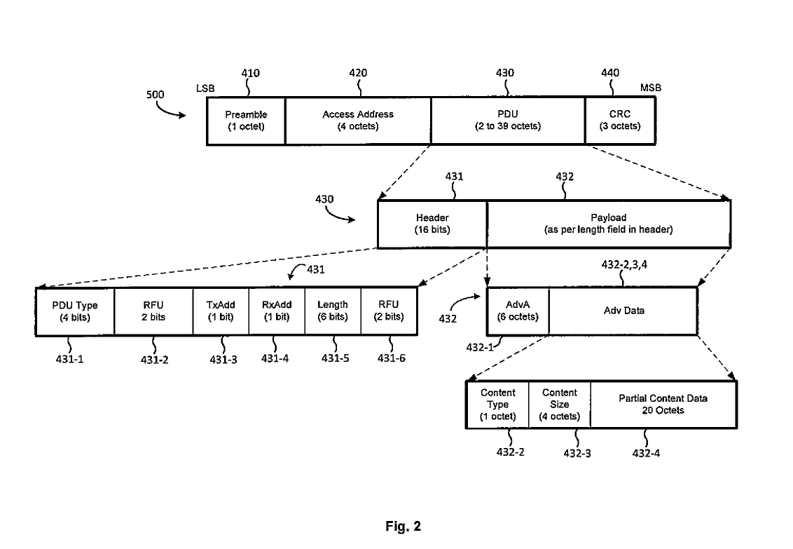

In the BLE standard, when a BLE packet is transmitted in an advertising physical channel, the packet is referred to as an advertising channel packet data unit (PDU). When a packet is transmitted in a data physical channel, the PDU is referred to as a data channel PDU. Examples of embodiments described herein utilise advertising channel PDUs. An advertising channel PDU according to examples of embodiments will now be described with reference to FIG. 2.

FIG. 2 shows the format of a BLE link layer packet 400 that contains a PDU 430. The PDU 430 is encapsulated in the link layer packet 400.

As shown in FIG. 2, there are four main components to the link layer packet (also referred to as a BLE message). The first part 410 is a preamble. The second part 420 is an Access Address. The third part 430 is the packet data unit (PDU). The fourth part 440 is a cyclic redundancy check (CRC) section.

In FIG. 2, the preamble 410 is one octet (eight data bits, also known as one byte). The preamble is used in the receiver to perform frequency synchronization, symbol timing estimation, and Automatic Gain Control (AGC) training. According to the BLE standard, advertising channel packets shall have 10101010b as the preamble. The data channel packet preamble is either 10101010b or 0101010 1b, depending on the least significant bit (LSB) of the Access Address 420.

The Access Address 420 is four octets. According to the BLE standard, The Access Address for all advertising channel packets is 10001110100010011011111011010110b (0x8E89BED6).

The PDU 430 is between 2 and 39 octets. The CRC 440 is three octets.

As shown in FIG. 2, the PDU 430 includes two main sections 431, 432. The first is the header 431, and the second is the payload 432. The header here has 16 bits (two octets). The payload 432 has a length that is between zero and 37 octets, as per the length field 431-5 in the header part 431 of the PDU 430.

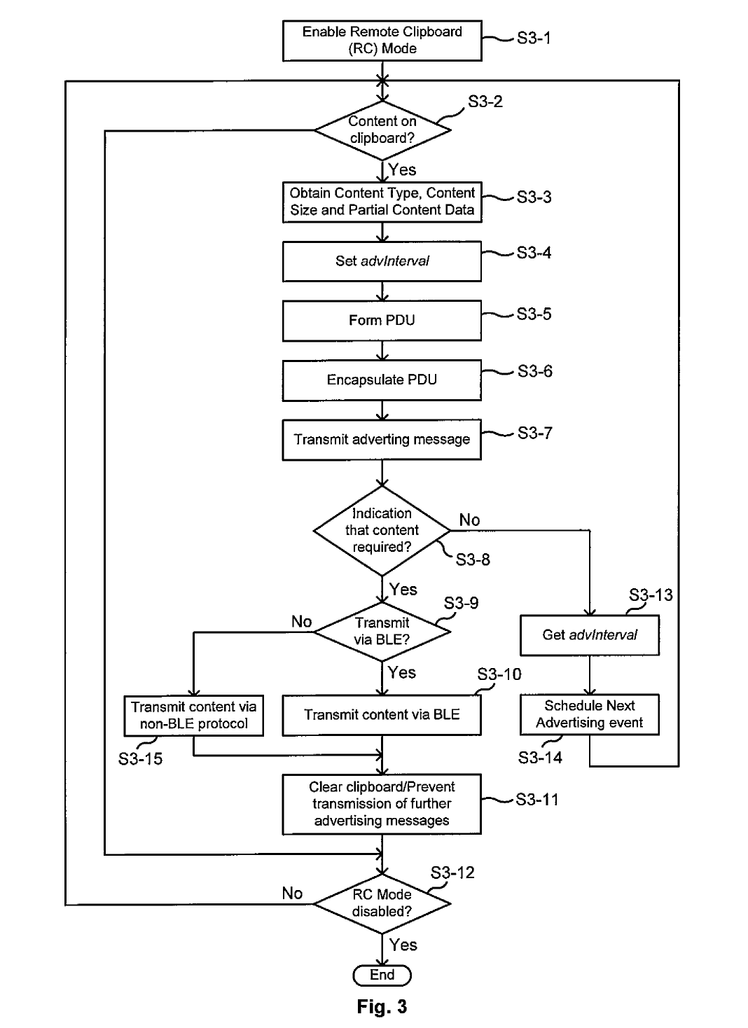

The header 431 is shown in FIG. 3 as being divided into six fields. The PDU type field 431-1 comprises four bits. A first reserved for future use (RFU) field 431-2 comprises two bits. A TxAdd field 431-3 is one bit. An RxAdd field 431-4 is one bit. The Length (or payload length) field 431-5 includes six bits. The sixth field is a second RFU field 431-6 which includes two bits.

The RFU bits (in sections 431-2 and 431-6) in the header of the PDU are reserved for future use (RFU) in version 4.0 of the BLE specification.

The current BLE specification defines several types of advertising channel PDU, e.g., ADV_IND, ADV_DIRECT_IND, ADV_NONCONN_IND and ADV_SCAN_IND (see Bluetooth V4.0, Vol. 6, Part B, Sec. 2.3). The type of the PDU is indicated in the PDU Type field 431-1 of the header 431. For example, ADV_IND PDUs are indicated by 0000 in the PDU Type field 431-1, ADV_DIRECT_IND PDUs are indicated by 0001, ADV_NONCONN_IND PDUs are indicated by 0010 and ADV_SCAN_IND PDUs are indicated by 0110.

Different types of PDU have different payload configurations. Some of the payload configurations (including that shown in FIG. 2) include an AdvA field 432-1 (which is 6 octets long) and AdvData field 432-2 (which is 0 to 31 octets long). In the BLE standard, the AdvA field 432-2 includes the advertiser's public or random device address as indicated. The type of address included in the AdvA field 432-1 is indicated in the TxAdd section 431-3 of the header 431. The AdvData field 432-2 may contain Advertising Data from the advertiser's Host.

According examples of embodiments, the BLE-capable apparatus 111 of the source terminal 110 may be configured to set the bits in the PDU Type field 431-1 of the header 431 to indicate a new PDU Type. Specifically, the BLE-capable apparatus may give the BLE advertising packet 500 a PDU Type having the following format:

| PDU Type (b₃b₂b₁b₀) | Packet Name |
|---|---|
| 0111 (or other reserved number) | ADV_RC |

In this specific example, the PDU Type field 431-1, which indicates that the packet is a Remote Clipboard (RC) type advertising packet, serves as the indication that the source terminal 110 has content for subsequent transmission to another BLE-capable terminal 120.

FIG. 2 shows an example of a payload configuration of an RC type advertising packet. In this example, the payload comprises the AdvA field 432-1 and the AdvData field 432-2, 3, 4. The AdvData field, in this example, comprises a Content Type field 432-2, a Content Size field 432-3 and a Partial Content Data field 432-4.

The content type field 432-2 is configured to indicate to the Recipient BLE-capable apparatus 121 the type of the content available for transmission. For example, the following indications may be used (although it will be appreciated that any suitable assignment of numbers to content type may instead be used):

| Content Type Field Bits | Content Type |
|---|---|
| 00x1 | Text |
| 00x2 | Image |
| 00x3 | File |
| Other numbers | Reserved for future use |

The content size field 432-3 indicates the size of the content for transmission. The partial content data field 432-4 includes at least a part of the content for allowing the recipient terminal 120 to provide a preview of the content for transmission, thereby to allow the user of the recipient terminal 120 to determine if the content is required.

In this specific example, the content type field 432-2 is one octet in length, the content size field 432-3 is four octets in length and the partial content data field 432-4 twenty octets in length. Consequently, in this example, the total payload length, including the AdvA data field 432-1 is thirty-one octets in length. An information table for an RC type advertising packet, with the specific configuration described above, may be as follows:

| PDU Type Field | Packet Name | Payload Octets | Field |
|---|---|---|---|
| 0111 (or other | ADV_RC | 1 to 6 | AdvA |
| reserved number) | | 7 | Content Type |
| | | 8 to 11 | Content Size |
| | | 12 to 31 | Partial Content Data |

Information such as this may be known by the recipient BLE-capable apparatus 121 to enable the recipient apparatus 121 to decipher the received BLE advertising packet 500.

It will of course be appreciated that embodiments of the invention may include payload configurations that are different to those described above. For example, certain fields may be omitted, different fields may be included in the payload 432, the order of the fields may be different and/or the length of one or more fields may be different to those described above.

FIG. 3 is a flow chart showing examples of operations which may be performed by the source terminal 110 of FIG. 1. The operations depicted in FIG. 3 provide a simple method whereby a user can copy and paste content between two different terminals. Put another way, the operations of FIG. 3 allow content to be “copied” from a source terminal 110 to a recipient terminal 120 at which it can be “pasted”.

In operation S3-1, the Remote Clipboard (RC) mode is enabled. This may be performed, for example, in response to a user of the terminal 110 selecting a selectable option from a menu presented on the display 108. Alternatively, the RC mode may be activated by any suitable input, for instance a voice command.

In operation S3-2, the processing circuitry 112 determines if there is content present in the virtual clipboard. This operation may comprise detecting that a copy operation in respect of content has been performed in response to a user input. For example, a user may specify via the user input interface 109 that content being viewed via the display 108 should be copied to the virtual clipboard. The terminal 120 may be configured to respond to performance of a copy operation in this way if it is in the RC mode. In other examples, the determination of operation S3-2 may be one of a plurality of periodic determinations as to the occupancy of the virtual clipboard. The performance of these periodic determinations may be triggered by the RC mode being enabled.

The content for transmission may be any suitable type including but not limited to text, an image or a file. As such, examples of embodiments of the present invention allow copying and pasting of part of the content of a file in addition to complete files.

If it is determined in operation S3-2 that there is content present on the virtual clipboard, the processing circuitry 112 responds by obtaining information relating to the content. This information may comprise the at least part of the content data for inclusion in a BLE advertising packet 500. In addition, the information may include the size of the content and/or the type of the content.

In operation S3-4, the processing circuitry 112 sets the advInterval. The advInterval defines the approximate time between the start of two consecutive advertising events and is discussed in version 4.0 of the Bluetooth Specification, (specifically, Volume 6, Part B-4.4.2.2). The advInterval may be set to, for example, 1 or 2 seconds. An advInterval of 2 seconds may be more suitable for use in crowded environments than is an advInterval of 1 second. As will, of course be appreciated, other durations may be used for the advInterval.

In operation S3-5, the processing circuitry 112 forms an advertising channel PDU which comprises the indication that the source terminal 110 has content available for transfer to another BLE-capable terminal. The advertising channel PDU may also include at least part of the content for enabling recipients of the packet 500 to provide a preview of the content. Formation of the advertising channel PDU comprises forming the header section 431, which may comprise setting the bits in the PDU Type field 431-1 to indicate that the packet is an RC type packet. As mentioned above, the indication that the packet is an RC type packet may constitute the indication that the source terminal 110 has content available for transfer to another BLE-capable terminal. Forming the header may also comprise setting the length field 431-5 to indicate the length of the payload. The TxAdd and RxAdd fields 431-3, 431-4 may also be set.

In addition to forming the header section 431, the processing circuitry 112 also forms the payload 432. This may comprise including in the payload 342 the part of the content data 432-4 for allowing the recipient terminal 120 to provide a preview of the content. Forming the payload 432 may also comprise setting the content type field 432-2 and/or the content size field 432-3.

In operation S3-6, the processing circuitry 112 encapsulates the PDU 430 to the form the BLE advertising packet 500. After this, in operation S3-7, the processing circuitry 112 causes the BLE advertising packet 500 to be transmitted. Transmission is performed via the transceiver 115 and the antenna 116.

After transmission of the BLE advertising packet 500, in operation S3-8 the processing circuitry 112 determines if an indication that the content is required to be transmitted has been received. Determination as to whether the indication has been received may comprise determining if a BLE message 600 (for example, including a SCAN_REQ PDU or a CONNECT_REQ PDU) has been received from a recipient terminal 120. If such a message 600 is received, the processing circuitry 112 may respond by causing an appropriate response message to be transmitted. For example, if a SCAN_REQ PDU is received, the processing circuitry 112 may cause a SCAN_RSP PDU to be transmitted to the recipient terminal 120. Similarly, if a CONNECT_REQ PDU is received, the processing circuitry may respond by causing transmission of a CONNECT_RSP PDU. After the exchange of BLE messages between the source and recipient terminals 110, 120, a BLE connection between the two devices may be set up. In some examples, operation S3-8 may comprise determining if a BLE connection has been set up. It should, however, be noted that such a connection cannot be set up without the source terminal 110 receiving a BLE message 600 from the recipient terminal 120. As such, it is implicit from a determination that the BLE connection has been set up that a BLE message has been received.

In response to determining in operation S3-8 that the content is required to be transmitted to the recipient terminal 120, the processing circuitry 112 determines in operation S3-9 whether the content is to be transmitted by BLE or by another protocol. This may be determined, for example, based on a property of the content such as but not limited to its size. For example, if the content size is over a threshold size, another non-BLE protocol may be used. If the content size is under the threshold a BLE connection, which may have been established as part of operation S3-8, may be used to transmit the content 700. The threshold may be, for example but not limited to, 500 KB. Protocols other than BLE include but are limited to Wi-Fi.

If it is determined that the content 700 is to be transmitted via BLE, operation S3-10 is performed in which the content 700 is transmitted to the source terminal 120 via a BLE connection. If it is determined that the content 700 is to be transmitted via a protocol other than BLE, the processing circuitry 112 proceeds to cause transmission of the content 700, in operation S3-15, by a protocol other than BLE. Initiation of the non-BLE connection for transferring the content may have been set up using the BLE connection which may have been established in operation S3-8. For example, parameters required for setting up the non-BLE connection may have been exchanged using the BLE connection. A determination as to which type of non-BLE protocol should be used may also have been determined using the BLE connection established in operation S3-8.

If in, operation S3-8, it is determined that no indication that the content is required has been received, the method proceeds to operation S3-13 in which the advInterval, as set in operation S3-4, is obtained. Subsequently, in operation S3-14, the advInterval is used to schedule the next advertising event. After this the method returns to operation S3-2. In the next advertising event, a BLE advertising packet having at least the same PDU as that transmitted in operation S3-7 may be transmitted. Such packets may continue to be transmitted until an indication that the content is required to be transmitted is received, until the content is transmitted, until the content is removed from the virtual clipboard or until the RC mode is disabled. There may be a limit on the number of successive RC type advertising events that are allowed to be performed. Transmission of RC type advertising packets may be discontinued when the limit is reached. The apparatus 111 may be configured to cycle through the different advertising channels each time an RC type advertising packet is transmitted.

After transmission of the content in either of operations S3-11 and S3-15, the method proceeds to operation S3-12. In operation S3-12, the processing circuitry 112 clears the virtual clipboard or prevents, in some other way, further advertising events relating to the transmitted content from being performed. For instance, the processing circuitry 112 may, instead of clearing the virtual clipboard, disable the RC mode. In this way, the content remains on the clipboard for further local use, or for transmission to a remote terminal, if RC mode is re-enabled.

Finally, it is determined in operation S3-12 if the RC mode has been disabled and, if so, the process ends. If it is determined that the RC mode is still active, the process returns to operation S3-2. Disabling of the RC mode may have been performed automatically in operation S3-11 following transmission of the content to recipient terminal 120. Alternatively, it may be manually disabled by the user of the source terminal 110.

It will of course be appreciated that the process depicted in FIG. 3 is an example only and that, as such, various operations may be omitted and/or other operations may be included. Similarly, the order in which operations are performed may, where applicable, be different to that shown in FIG. 3. In one example of a variation of the process depicted in FIG. 3, operations S3-1 and S3-2 may be omitted and may be replaced by a single operation in which a user input indicating that content is required to be copied to a remote terminal is received. Selection of a “remote copy” operation such as this may be distinct from a local copy operation in which the user requires copying and pasting of within the source terminal 110. This user input for causing the “remote copy” operation may be provided in any suitable way, one such way being a user selection in respect of displayed content (e.g. touch and hold on a touchscreen) followed by a subsequent selection of a remote copy option from a menu that appears in response to the user selection of the content. Subsequent to receipt of this user input, operation S3-3 is performed. In this example, operation 3-12 may also be omitted.

Other operations which may be performed by the source terminal 110 but which are not depicted in FIG. 3 relate to authentication of the recipient terminal 120. This may prevent an unauthorised terminal receiving content which is confidential or which is otherwise not intended for that terminal. For example, in response to receiving the indication that the content is required to be transmitted to the recipient terminal 120, the source terminal 110 may initiate an authentication process. For example, the source terminal 110 may send a request to the recipient terminal 120 that a passkey be entered by the user of the recipient terminal 120. Only in response to receipt of a valid passkey, will the method proceed to transmission of the content. In some examples, the authentication process may require passkeys to be entered at both terminals. The use of an authentication process allows the BLE connection to be encrypted and, as such, any shared secrets which may be required in later pairing between the devices (for example, for the non-BLE transmission of the content in operation S3-15) can be safely distributed. In some examples, the authentication process may be waived if the recipient terminal is recognised (e.g. is on a “white list”).

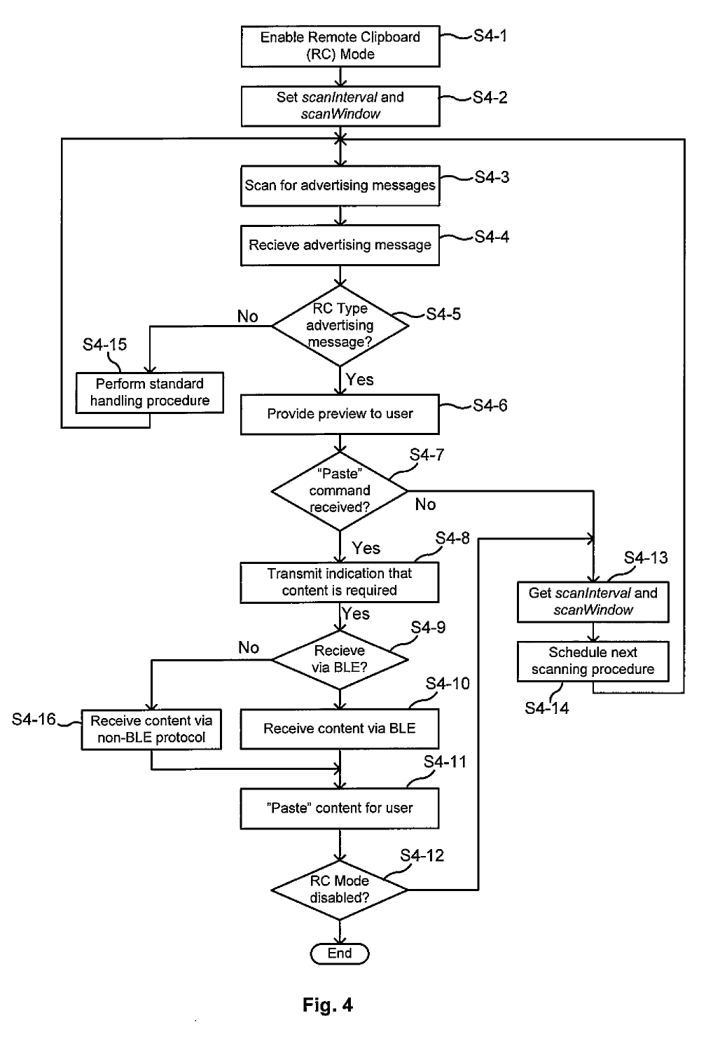

FIG. 4 is a flowchart showing examples of operations which may be performed by the recipient terminal 120 of FIG. 1. The operations of FIG. 4 allow content “copied” at a remote source terminal to be “pasted” at the recipient terminal.

In operation S4-1, the Remote Clipboard (RC) mode is enabled. This may be performed, for example, in response to a user of the terminal 110 selecting a selectable option from a menu presented on the display 108, or in any other way.

In operation S4-2, the processing circuitry 122 sets the scanInterval and the scanWindow. The scanWindow defines the duration for which the recipient BLE-capable apparatus 121 listens on one of the advertising channels. The scanInterval defines the interval between two consecutive scan windows. The scanInterval and scanWindow parameters are discussed in version 4.0 of the Bluetooth Specification, (specifically, Volume 6, Part B-4.4.3 and 4.4.4). The scanWindow may be set to, for example, 2 seconds. The scan interval may be set to, for example, 30 seconds. It will of course be appreciated that other values of the scanWindow and scanInterval may alternatively be used.

Next, in operation S4-3, the apparatus 121 scans for BLE advertising packets and, in operation S4-4, receives a BLE advertising packet 500 (for example, having a format similar to that described with reference to FIG. 2) from the source terminal 110.

In operation S4-5, the processing circuitry 122 determines whether the received BLE advertising packet is an RC type advertising packet. This may be performed by examining the PDU Type field 431-1 in the header 431 of the PDU 430.

If it is determined that the BLE packet is not an RC type advertising packet, operation S4-15 is performed in which the packet is handled in a standard manner, depending on the type of the packet.

If it is determined that the BLE packet is an RC Type advertising packet, the processing circuitry 122 may, in operation S4-6, use the at least part of the content data included in the packet to provide a preview of the content to the user, for example, via the display 208. The preview may be provided only after user selection of a selectable option or icon. The selectable option or icon may be enabled in response to detection that the received packet is an RC type advertising packet. A preview of the content may be provided in any suitable way. For example, the preview may comprise a portion of text from the content, a thumbnail or other low resolution version of an image, a title of a file. Providing a preview to the user may allow the user to ensure that content of interest is received. This may be particularly useful in a busy area in which multiple devices are each transmitting RC type advertising packets relating to different content.

In operation S4-7, it is determined if a paste command has been received. Put another way, it is determined if the user has provided an indication that they require the content to be transmitted from the source terminal 110 to the recipient terminal 120. A paste command may be provided by user-selection of a selectable option, which is enabled (e.g. provided on the display) following determination that the received packet is an RC type advertising packet. The selectable option may be displayed concurrently with or separately from the preview of the content. In one specific example, the selectable option for pasting the remote content may be displayed in response to user selection of the preview of the content.

If it is determined that a paste command has not been received, for example, because no user input is received or because a user input declining receipt of the content is received, the operation proceeds to operation S4-13. In operation, S4-13, the processing circuitry 122 obtains the scanlnterval and scanWindow. In operation, S4-14, the processing circuitry 122 schedules the next scanning procedure. After this, the process returns to operation S4-3.

If it is determined that a paste command has been received, the processing circuitry 122 causes an indication of this to be transmitted to the source terminal 110. As described with reference to operation S3-8 of FIG. 3, this indication may be in the form of a BLE message, such as a SCAN_REQ or a CONNECT_REQ. Following this, a BLE connection may be established between the source terminal 110 and the recipient terminal 120.

Next, in operation S4-9, it is determined if the content should be received via BLE. This may be determined by either of the source or recipient terminals 110, 120, with the other terminal being informed of the outcome of the determination. The determination may be as described with reference to operation 3-9 of FIG. 3.

If it is determined that the content is to be received via BLE, operation S4-10 performed in which the content 700 is received at the recipient terminal 120 via a BLE connection. If it is determined that the content 700 is to be transmitted via a protocol other than BLE, the content 700 is received, in operation S4-16, by a protocol other than BLE. Initiation of the non-BLE connection for transferring the content may have been set up using the BLE connection which may have been established following operation S4-8. For example, parameters required for setting up the non-BLE connection may have been exchanged using the BLE connection. A determination as to which type of non-BLE protocol should be used may also have been determined using the BLE connection established following operation S4-8.

Subsequent to receipt of the content 700 in either of operations S4-10 and S4-16, the processing circuitry 122 causes, in operation S4-11, the content to be “pasted”. Put another way, the content (or a representation thereof) is caused to be provided to the user, for example, via the display 208.

Finally, in operation S4-12, it is determined if the RC Mode has been disabled and, if so, the process ends. If the RC Mode is still enabled, the method proceeds to operation S4-13. The RC Mode may be disabled automatically in response to having received the content 700 from the source terminal 110 in either of operations S4-16 and S4-10, or in response to the content having been “pasted” at the recipient terminal in operation S4-11. Alternatively, the RC mode may be disabled manually by the user of the recipient terminal 120.

It will, of course be understood that the flow of operations depicted in FIG. 4 is an example only and that, in other examples, certain operations may be omitted and/or other operations may be included and/or the order in which operations are performed may be different to that depicted. One example of an additional operation is a determination as to whether the source terminal is an allowed terminal. For example, the recipient terminal 120 may maintain a list of allowed terminals from which it is allowed to receive content. This list may be referred to as a “white list”. Alternatively, the terminal 120 may maintain a “black list” specifying remote terminals from which the terminal 120 is not allowed to receive content. The list (either white or black) may have been compiled in any suitable way. The determination as to whether the source terminal 120 is an allowed terminal may be performed in response to receiving the BLE advertising packet 500 in operation S4-4 or in response to determining that the received packet is an RC type advertising message in operation S4-5. The determination may be performed by examining the AdvA field 432-1 in the payload of the packet. By comparing the address in the AdvA field 432-1 with information present in the list, the recipient terminal 120 is able to determine whether the source terminal 120 is an allowed terminal. If it is determined that the source (or advertising) terminal is an allowed terminal, the method progresses, for example, to operation S4-6. If it is determined that the source terminal is not an allowed terminal, the received BLE packet is disregarded and the method proceeds to operation S4-13.

An example of another operation which may be performed by the recipient terminal 120 may be the implementation of a validity period in respect of a received RC type advertising packet. This may be implemented using a timer. For example, a timer having a particular duration (which indicates the validity period) may be started in response to determining, in operation S4-5, that the receive BLE packet is an RC Type advertising packet. If the timer expires prior to an indication that the content is required has been received, the RC type BLE advertising packet is disregarded or deleted such that the information contained therein is not longer accessible by the user of the terminal 120. After deleting or disregarding the RC type packet 500, it may not be possible for the terminal to receive the content based on that packet. The use of a validity period ensures that the recipient terminal does not maintain, or display information relating to, one or more unwanted RC type advertising packet indefinitely.

A generic RC mode has been described with reference to FIGS. 3 and 4. However, it will be appreciated that there may instead be two different Remote Clipboard modes activatable by the user. An RC mode for copying content to another terminal may be referred to as the RC Copy mode, whereas an RC mode for pasting content from another terminal may be referred to as the RC Paste mode. In the RC Copy mode, the source terminal 110 may be operable to cause the formation and transmission of BLE advertising packets 500 as described with reference to operations 3-5 to 3-7. In the RC Paste mode, the recipient terminal 120 may be operable to scan for and handle RC type BLE packets as described with reference to operations S4-2 to S4-11. Each of the terminals 110, 120 may be capable of operating in both modes such that content can be copied and pasted in either direction.

Some further details of components and features of the above-described devices and alternatives for them will now be described.

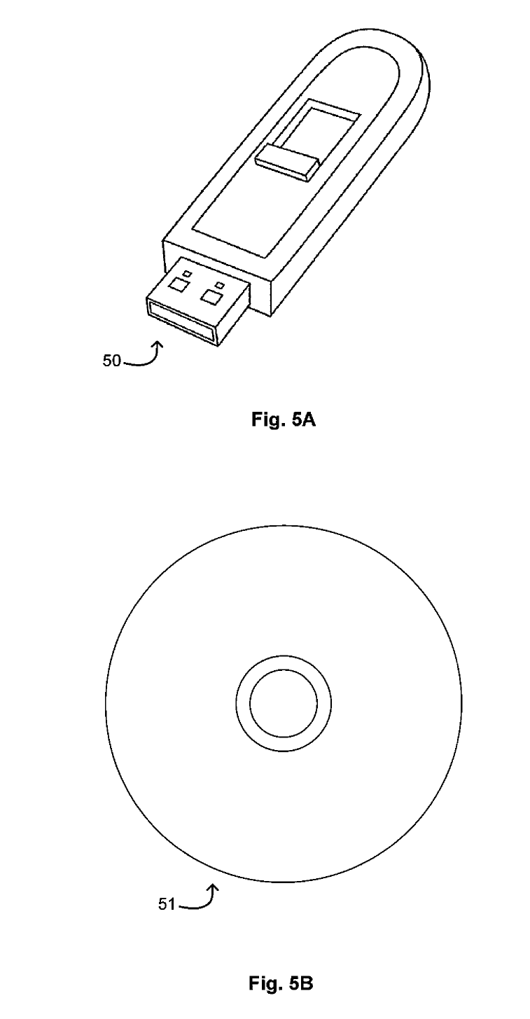

The computer program instructions 117, 127 may provide the logic and routines that enables the respective BLE-capable apparatus 111, 121 to perform the functionality described above. The computer program instructions 117, 127 may be pre-programmed into the BLE-capable apparatus 111, 121. Alternatively, they may arrive at the BLE- capable apparatus 111, 121 via an electromagnetic carrier signal or be copied from a physical entity such as a non-transitory computer-readable memory medium 50, 51. Examples of such a non-transitory computer-readable memory medium 50, 51 (which may be referred to as a computer program product) include a non-volatile electronic memory device 50 (e.g. flash memory) which is depicted in FIG. 5A and a record medium 51 such as a CD-ROM or DVD which is depicted in FIG. 5B.

The processing circuitry 112, 122 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 112 may be termed processing means.

Typically, the BLE-capable apparatus 111, 121 comprises at least one processor 112, 122, coupled/connected to both volatile memory 113, 123 and non-volatile memory 114, 124. The computer program is stored in the non-volatile memory 114, 124 and is executed by the processor 112, 122 using the volatile memory 113, 123, 133 for temporary storage of data or data and instructions. Examples of volatile memory include RAM, DRAM, SDRAM etc. Examples of non-volatile memory include ROM, PROM, EEPROM, flash memory, optical storage, magnetic storage, etc.

The BLE-capable apparatus 111, 121 may be a single integrated circuit. It may alternatively be provided as a set of integrated circuits (i.e. a chipset). The BLE-capable apparatus 111, 121 may alternatively be a hardwired, application-specific integrated circuit (ASIC).

The additional components 119, 129, if there are any, may be arranged in any suitable way. For instance, there may be provided processing circuitry, including one or more processors, and a storage device, comprising a single memory unit or a plurality of memory units. The processing circuitry may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 112 may be termed processing means. The storage device may store computer program instructions that, when loaded into the processing circuitry, control the operation of the respective terminal 110, 120. The computer program instructions may provide the logic and routines that enable the terminal 110, 120 to provide functions of the device that are not provided by the BLE-capable apparatus 111, 121 on its own. The computer program instructions may be pre-programmed into the terminal 110, 120. Alternatively, they may arrive at the terminal 110, 120 via an electromagnetic carrier signal or be copied from a physical entity such as a computer program product, a non-volatile electronic memory device (e.g. flash memory) or a record medium such as a CD-ROM or DVD.

Typically, the components 119 of the terminals 110, 120 comprises a processor coupled connected to both volatile memory and non-volatile memory. The computer program is stored in the non-volatile memory and is executed by the processor using the volatile memory for temporary storage of data or data and instructions. Examples of volatile memory include RAM, DRAM, SDRAM etc. Examples of non-volatile memory include ROM, PROM, EEPROM, flash memory, optical storage, magnetic storage, etc.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories.

The apparatuses and terminals described herein may comprise further optional SW components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

Any of the computer programs described above, may be implemented in a computer program product comprising a tangible computer-readable medium bearing computer program code embodied therein which can be used with the processor for the implementation of the functions described above.

The computer program instructions may arrive at the apparatus via an electromagnetic carrier signal or be copied from a physical entity such as a computer program product, a memory device or a record medium such as but not exclusively a CD-ROM or DVD, and/or an article of manufacture that tangibly embodies the computer program.

Reference to “computer-readable storage medium”, “computer program product”, “tangibly embodied computer program” etc, or a “processor” or “processing circuitry” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-73. (canceled)

74. Apparatus comprising:
at least one processor; and
at least one memory including computer program code, the at least one memory and the computer program code configured to, with the at least one processor, cause the apparatus at least:
to cause formation and transmission from a first terminal of a Bluetooth low energy (BLE) advertising packet, the BLE advertising packet comprising an indication that content is available for transmission; and
to respond to receipt from a second terminal, which received the BLE advertising packet, of an indication that the content is required to be transmitted to the second terminal by causing transmission of the content from the first terminal to the second terminal,
wherein the BLE advertising packet comprises an indication of a type of the content available for transmission.

75. The apparatus of claim 74, wherein the BLE advertising packet comprises an indication of a size of the content available for transmission.

76. The apparatus of claim 74, wherein the indication that the content is required to be transmitted to the second terminal is, or is included in, another BLE packet.

77. The apparatus of claim 74, the at least one memory and the computer program code being configured to, with the at least one processor, cause the apparatus to cause the formation and transmission of the BLE advertising packet in response to a determination that the content is present in a virtual clipboard.

78. The apparatus of claim 77 wherein the determination that the content is present in the virtual clipboard comprises detection of performance of a copy operation in which the content is copied to the virtual clipboard.

79. The apparatus of claim 74, wherein the BLE advertising packet comprises at least part of the content for enabling the second terminal to provide a preview of the content to a user.

80. The apparatus of claim 74, the at least one memory and the computer program code being configured to, with the at least one processor, cause the apparatus to determine, based on at least a property associated with the content, a transmission protocol by which to transmit the content from the first terminal to the second terminal.

81. The apparatus of claim 74, the at least one memory and the computer program code being configured to, with the at least one processor, cause the apparatus to respond to receipt of the indication that the content is required to be transmitted or to the transmission of the content by preventing further transmissions of the BLE advertising packet.

82. Apparatus comprising:
at least one processor; and
at least one memory including computer program code, the at least one memory and the computer program code configured to, with the at least one processor, cause the apparatus at least:
to enable receipt from a first terminal at a second terminal a Bluetooth low energy (BLE) advertising packet, the BLE advertising packet comprising an indication that content is available for transmission from the first terminal;
to cause transmission to the first terminal of an indication that the content is required to be transmitted to the second terminal; and
to enable receipt of the content from the first terminal at the second terminal,
wherein the BLE advertising packet includes an indication of a type of the content available for transmission.

83. The apparatus of claim 82, wherein the BLE advertising packet includes at least part of the content that is available for transmission from the first terminal

84. The apparatus of claim 83, the at least one memory and the computer program code being configured to, with the at least one processor, cause the apparatus to cause provision to the user of the second terminal, based on the at least part of the content included in the advertising packet, a preview of the content that is available for transmission.

85. The apparatus of claim 82, wherein the BLE advertising packet includes an indication of a size of the content available for transmission.

86. The apparatus of claim 82, the at least one memory and the computer program code being configured to, with the at least one processor, cause the apparatus to cause the transmission of the indication that the content is required to be transmitted to the second terminal in response to receipt of a user input indicating that the content is required to be transmitted.

87. Apparatus comprising:
at least one processor; and
at least one memory including computer program code, the at least one memory and the computer program code configured to, with the at least one processor, cause the apparatus at least:
to cause formation and transmission from a first terminal of a Bluetooth low energy (BLE) advertising packet, the BLE advertising packet comprising:
an indication that content is available for transmission; and
at least one of:
at least part of the content for enabling a second terminal, which receives the BLE advertising packet, to provide a preview of the content to a user;
an indication of a size of the content available for transmission,
wherein the BLE advertising packet includes an indication of a type of the content available for transmission.

88. The apparatus of claim 87, the at least one memory and the computer program code being configured to, with the at least one processor, cause the apparatus to determine, based on at least a property associated with the content, a transmission protocol by which to transmit the content from the first terminal to the second terminal.

89. The apparatus of claim 87, the at least one memory and the computer program code being configured to, with the at least one processor, cause the apparatus to respond to receipt of the indication that the content is required to be transmitted or to the transmission of the content by preventing further transmissions of the BLE advertising packet.

90. The apparatus of claim 87, the at least one memory and the computer program code being configured to, with the at least one processor, cause the apparatus to cause the formation and transmission of the BLE advertising packet in response to a determination that the content is present in a virtual clipboard.

91. The apparatus of claim 90 wherein the determination that the content is present in the virtual clipboard comprises detection of performance of a copy operation in which the content is copied to the virtual clipboard.

92. The apparatus of claim 87, the at least one memory and the computer program code being configured to, with the at least one processor, cause the apparatus to respond to receipt from a second terminal, which received the BLE advertising packet, of an indication that the content is required to be transmitted to the second terminal by causing transmission of the content from the first terminal to the second terminal
